(19) United States
(12) Patent Application Publication
(10) Pub. No.: US 2026/0252476 A1
(43) Pub. Date: Aug. 27, 2026

(54) SYSTEMS AND METHODS FOR AN IMPROVED SYNTHETIC MONITOR MANAGEMENT TOOL

(71) Applicant: The PNC Financial Services Group, Inc., Pittsburgh, PA (US)

(72) Inventors: Michael NITSOPOULOS, Pittsburgh, PA (US); Palamayuran SURENTHIRAN, Pittsburgh, PA (US)

(73) Assignee: The PNC Financial Services Group, Inc., Pittsburgh, PA (US)

(21) Appl. No.: 19/309,188

(22) Filed: Aug. 25, 2025

Related U.S. Application Data
(60) Provisional application No. 63/761,422, filed on Feb. 21, 2025.

(51) Int. Cl. G06F 11/3668

(52) U.S. Cl. CPC G06F 11/3692

(57) ABSTRACT

A system and method for automated provisioning and lifecycle management of synthetic monitors are described. In some embodiments, synthetic monitors may be defined using monitor configuration files that may be stored in a distributed version control system, ensuring traceability and version control. Updated monitor configuration files may trigger a pull request that may require approval before merging into the distributed version control system. When a configuration file is updated, a continuous integration pipeline may validate the modifications, checking for syntax errors and completeness. A continuous delivery pipeline may then apply the validated updates to the synthetic monitoring system via an application programming interface (API), automating the creation, activation, deactivation, and deletion of synthetic monitors. The system may support scalability by managing numerous synthetic monitors simultaneously and maintaining logs of certain or all changes for audits and roll-backs.

### CROSS REFERENCE TO RELATED APPLICATIONS

This application claims the benefit of priority to U.S. Provisional Application Ser. No. 63/761,422, filed on Feb. 21, 2025, the contents of which are incorporated herein by reference in their entirety.

### BACKGROUND

The present disclosure relates generally to systems and methods for synthetic monitor management. More specifically, the present disclosure relates to creating, updating, activating, deactivating, querying the status of, and deleting synthetic monitors, thus allowing the active monitoring of services and routes in an enterprise-level container orchestration cluster. These tasks may be accomplished via a graphical user interface, a distributed version control system, and continuous integration and delivery pipelines. A single sign-on and identity and access management system may also be used for user validation.

An institution may handle vast numbers of transactions and requests simultaneously across platforms including web portals, mobile applications, and internal systems, creating a significant demand on the institution's platforms. To meet this demand, synthetic monitoring allows the institution to actively scale its platforms' capacity for increased demand, thus maintaining high levels of performance and reliability.

Enterprise-level container orchestration enables institutions to efficiently handle dynamic workloads. With a containerized microservices architecture, institutions can deploy individual services—such as transaction processing, user account management, or analytics—as independent units. Orchestration platforms allow these services to scale automatically based on demand. For example, during peak periods such as market hours or bill payment cycles, orchestration tools may ensure that additional resources are allocated to manage increased traffic. This scalability may minimize delays and ensure a seamless user experience by reducing latency and maintaining service-level agreements. Scalability can also mitigate attempted denial-of-service attacks by increasing compute capacity to serve legitimate requests. For example, during attempted denial-of-service attacks, the system may dynamically scale up its compute resources to absorb the surge in traffic. This scaling may help ensure that legitimate user requests are still processed in a timely manner, even as malicious traffic attempts to overwhelm the system, and thus reduces the likelihood of dropped requests and maintain service continuity.

Synthetic monitoring complements enterprise-level container orchestration by providing proactive insights into application performance and user interactions. By simulating user actions—such as logging into an account, initiating a transfer, or retrieving transaction histories—synthetic monitoring tools may continuously test system functionality. These tests help identify performance bottlenecks, slow response times, or system outages before they impact users. This proactive approach ensures that issues are resolved quickly, keeping services available and responsive.

Moreover, synthetic monitoring offers visibility into geographic and platform-specific performance. Institutions often serve a diverse customer base across different regions and devices. Synthetic tests can pinpoint issues that may only affect users in specific locations or using particular platforms, enabling teams to take targeted actions. Coupled with container orchestration, these insights can trigger resource adjustments or redeployment of services in specific environments to optimize performance.

Together, enterprise-level container orchestration and synthetic monitoring may provide the foundation for resilient, high-performing applications in institutions. Enterprise-level container orchestration and synthetic monitoring allows organizations to scale operations efficiently, maintain a seamless user experience, and address potential performance challenges proactively, ensuring reliability even during periods of increased or peak activity. These tools can be important in managing the complex and high-demand environments that institutions operate within.

Current synthetic monitoring tools often face limitations in their ability to provide a comprehensive view of system performance. Some current synthetic monitoring tools rely on predefined scripts and workflows, which can fail to account for dynamic or unexpected user behaviors. As a result, these tools may miss important performance issues that arise from real-world interactions, leading to gaps in monitoring effectiveness.

Another shortcoming of current synthetic monitoring tools may be a heavy reliance on static test environments. Synthetic monitoring tools may simulate user interactions in controlled environments that do not reflect the complexity of production systems. Variations in real-time traffic patterns, infrastructure dependencies, or third-party service performance are often excluded, resulting in incomplete or misleading insights about application behavior under actual usage conditions.

Additionally, some synthetic monitoring tools struggle with scalability. As applications grow in complexity, with multiple endpoints, microservices, and regions to cover, maintaining and updating monitoring scripts can become resource-intensive. The tools may not adapt easily to evolving systems, leaving blind spots in performance tracking, particularly in large, distributed environments.

Synthetic monitoring tools also tend to focus heavily on front-end performance, such as page load times or response rates, without adequately addressing back-end dependencies or infrastructure-level bottlenecks. This narrow scope can lead to situations where an application appears healthy at the surface level but faces significant issues in its underlying systems, such as database latency or resource contention.

Synthetic monitoring tools also may lack integration capabilities with broader observability ecosystems, such as real user monitoring or logging frameworks. Without this integration, teams must manually correlate synthetic data with other performance metrics, increasing the risk of misdiagnosing issues or delaying resolution.

These limitations highlight the need for synthetic monitoring solutions that are dynamic, scalable, and deeply integrated with modern application ecosystems to provide a more accurate and actionable view of performance.

An improved synthetic monitor management tool, according to some embodiments of the current disclosure, provides enhanced system scalability and addresses each of the limitations of existing synthetic monitor management tools in part by hyper-automating the maintenance of synthetic monitors transparently in the continuous integration and delivery pipelines.

### SUMMARY

Systems and methods for an improved synthetic monitor management tool are provided. The systems and methods may include creating, updating, activating, deactivating, querying the status of, and deleting synthetic monitors to active monitor services and routes in an enterprise-level container orchestration cluster.

Some embodiments include a system for managing synthetic monitors comprising a memory storing instructions and a processor configured to execute those instructions. In such embodiments, the system may receive a request from a user device to manage a synthetic monitor and the system may generate a synthetic monitor configuration file based on the request. The system may create a pull request in a distributed version control system, which may merge the configuration file into a repository to form an updated repository. Access to this updated repository may be granted to a continuous integration (CI) pipeline, which may be configured to detect the update and verify that the configuration file meets a predefined set of requirements. These requirements may include, but are not limited to, a syntax check, static analysis, compliance confirmation, unit testing, integration testing, and performance testing. Upon successful validation, the CI pipeline may convert the configuration file into a validated synthetic monitor configuration file. This validated file may be passed to a continuous delivery (CD) pipeline, which is granted access to deploy the file to a synthetic monitor management tool. The validated configuration file may be executed on the synthetic monitor management tool, enabling automated and reliable deployment of synthetic monitors.

In some embodiments, a method for creating a new synthetic monitor is provided. Such a method may include receiving a user request from a user device. In some embodiments, the request may include instructions for creating a new synthetic monitor. The system may generate a synthetic monitor configuration file based on the received request. Additionally, the system may generate a pull request that incorporates the instructions contained in the user request. The system may merge the synthetic monitor configuration file into a repository. In some embodiments, the repository may contain one or more existing synthetic monitors. The system may also perform one or more tests on the instructions included in the user request. These tests may include, for example, a syntax check, a static analysis, a compliance confirmation, a unit test, an integration test, and/or a performance test. In some embodiments, the system may compare the synthetic monitor configuration file to one or more existing synthetic monitors stored in the repository. If the configuration file includes at least one parameter that matches a parameter in an existing synthetic monitor, the system may delete the existing synthetic monitor from the repository. Furthermore, the system may execute the instructions included in the user request. This execution may enable the deployment or activation of the new synthetic monitor, thereby facilitating secure and efficient synthetic monitoring operations.

In some embodiments, a system for managing a synthetic monitor is provided. Such a system may include a memory configured to store instructions. The system may also include a processor configured to execute the stored instructions. The processor may be configured to receive a request from a user device to manage a synthetic monitor. In some embodiments, the processor may request at least one authentication credential from the user device. The processor may transmit the received request to an identity and access manager, which may be configured to attempt to verify the user device. Additionally, the processor may read the request from the user device to determine the intended management operation for the synthetic monitor. Based on the request, the processor may generate a synthetic monitor configuration file. This configuration file may be used to define parameters or behaviors associated with the synthetic monitor, enabling secure and structured management of synthetic monitoring operations.

Some embodiments include a system for managing synthetic monitors. In some embodiments, synthetic monitors may be managed through version-controlled monitor configuration files in a repository within a distributed version control system, rather than directly interacting with the synthetic monitoring system manually. In some embodiments, the distributed version control system may be configured to store monitor configuration files that may have a structured format (e.g., JavaScript Object Notation (“JSON”)) and contain parameters or details about synthetic monitors. In some embodiments, such parameters and details about synthetic monitors may include a target endpoint, monitoring frequency, success criteria, and/or test types. In some embodiments, the monitor configuration files may serve as blueprints for synthetic monitors, enabling traceable and version-controlled updates.

In some embodiments, changes to the monitor configuration files may be implemented via a continuous integration pipeline. In some embodiments, the continuous integration pipeline may be triggered when a monitor configuration file is modified or updated in the distributed version control system repository. The continuous integration pipeline may be configured to read the updated monitor configuration file, validate it for errors, and pass it to a continuous delivery pipeline, which may apply it to the synthetic monitoring system. Validation by the continuous integration and delivery pipelines may include syntax checks, which may ensure that certain or all required parameters are present and correctly formatted. In some embodiments, the continuous integration and delivery pipelines may also include automated testing to verify the correctness of the configuration before and after deployment.

In some embodiments, the continuous delivery pipeline may communicate with the synthetic monitoring system programmatically via an application programming interface (“API”). The API may be configured to allow the continuous delivery pipeline to send commands to create, update, delete, activate, or deactivate synthetic monitors based on the details defined in the configuration files. In some embodiments, API communication may provide a scalable and consistent method for managing synthetic monitors across multiple systems or environments. However, the system may not be limited to API-based communication, and other mechanisms may be used for interacting with the synthetic monitoring system.

In some embodiments, the system may provide traceability and auditability by storing certain or all changes to synthetic monitor configurations in the distributed version control system. The distributed version control system may be configured to maintain a complete history of updates, including timestamps, descriptions of changes, and the identity of the user who made each change. In some embodiments, this version-controlled approach may facilitate collaboration among team members and provide a clear audit trail for some or all monitoring-related modifications.

In some embodiments, the synthetic monitoring system may be configured to provision synthetic monitors automatically based on the configuration files deployed by the continuous delivery pipeline. This provisioning may include setting up the monitors to execute specific tests, assigning resources (e.g., test agents in specific geographic locations), and scheduling tests according to predefined frequencies. In some embodiments, the provisioning process may begin immediately after validation and deployment, ensuring that the synthetic monitors are operational with minimal delay.

In some embodiments, the system may support scalability by enabling the management of numerous synthetic monitors simultaneously. The use of a distributed version control system and continuous delivery pipelines may ensure that updates to monitors are applied uniformly, reducing the likelihood of misconfigurations or inconsistencies. In some embodiments, this approach may also reduce manual intervention, thereby enhancing operational efficiency and reducing the potential for human error.

Embodiments according to the present disclosure may allow faster time-to-market by hyper-automating the maintenance of synthetic monitors transparently in the continuous delivery pipelines.

In some embodiments, one or more devices that are configured or operable to perform the above-described systems and methods are disclosed.

The above and other aspects and their implementations are described in greater detail in the drawings, the descriptions, and the claims.

### BRIEF DESCRIPTION OF FIGURES

FIG. 1 is a schematic diagram of members of an institution expressing their desire to improve application performance, availability, and reliability, consistent with some disclosed embodiments.

FIG. 2A is a schematic diagram of members of an institution referring to a system directed to improving system responsiveness, consistent with some disclosed embodiments.

FIG. 2B is a diagram of a user utilizing a system directed to improving system responsiveness, consistent with some disclosed embodiments.

FIG. 2C is a diagram of a system directed to improving system responsiveness, consistent with some disclosed embodiments.

FIG. 3 is a schematic block diagram of a system capable of managing synthetic monitors, consistent with disclosed embodiments.

FIG. 4A is a flow diagram of a method of integrating new or updated synthetic monitors using a synthetic monitoring tool, consistent with disclosed embodiments.

FIG. 4B is a flow diagram of a method of deploying new or updated synthetic monitors using a synthetic monitoring tool, consistent with disclosed embodiments.

FIG. 5 is a schematic block diagram of a system capable of validating a user of a synthetic monitor management tool, consistent with disclosed embodiments.

FIG. 6 depicts an example of computing device 600, consistent with disclosed embodiments.

### DETAILED DESCRIPTION

Reference will now be made in detail to exemplary embodiments, discussed with reference to the accompanying drawings. Unless otherwise stated, technical and/or scientific terms have the meaning commonly understood by one of ordinary skill in the art. It is to be understood that other embodiments may be implemented and that changes may be made without departing from the scope of the disclosed embodiments. For example, unless otherwise indicated, method steps disclosed in the figures may be rearranged, combined, or divided without departing from the envisioned embodiments. Phrases that tend to indicate an order of events, such as “before,” “prior to,” then,” “after,” and the like are not intended to be limiting. Similarly, additional steps may be added, or steps may be removed, without departing from the envisioned embodiments. Thus, the materials, methods, and examples are illustrative only and are not intended to be necessarily limited.

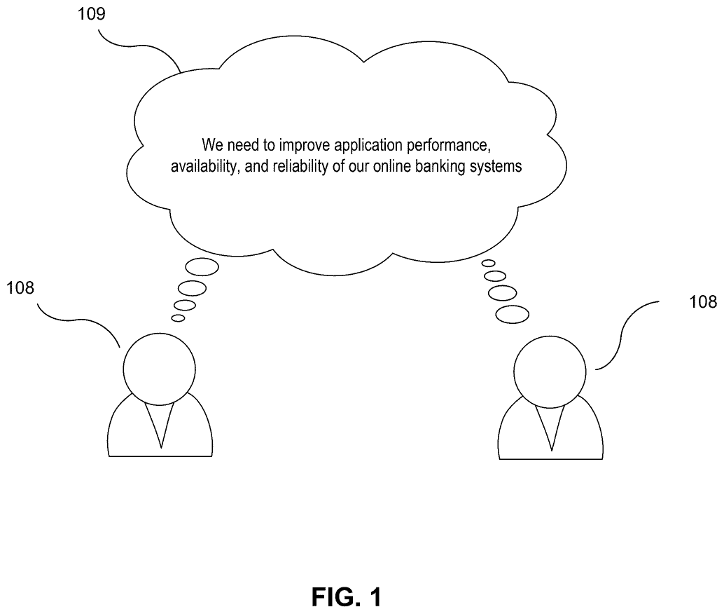

FIG. 1 is a schematic diagram of members of an institution expressing their desire to improve application performance, availability, and reliability, consistent with some disclosed embodiments. Stakeholders 108 may express a desire 109 to improve application performance, availability, and reliability of their online banking systems, consistent with disclosed embodiments. Stakeholders 108 may include corporate directors, information technology (IT) staff, or others at a banking company.

Application performance may refer to how efficiently and quickly an application executes its tasks, processes user requests, and delivers results under various conditions. Response time may be a metric of application performance and may include the time it takes for the application to process a request and return a result. Throughput may be a metric of application performance and may include the number of transactions or requests an application can handle per unit of time. Latency may be a metric of application performance and may include the delay, if any, between a user action and the application's response. Good application performance may help to ensure a smooth user experience, support high traffic loads, and reduce user frustrations.

Application availability may refer to the degree to which an application is operational, accessible, and usable at any given time. Application availability may be expressed as a percentage of uptime over a specified period (e.g., 99.9% uptime). Uptime may be a metric of application availability and may include the amount of time an application is accessible and functioning correctly. Downtime may be a metric of application availability and may include the amount of time the application is unavailable or non-functional. Mean time between failures may be a metric of application availability and may include the average time between system failures. High application availability may help ensure users can rely on the application when needed, which may be important for customer trust, business continuity, and compliance with service level agreements.

Application reliability may refer to the ability of an application to perform its intended functions without failure under expected conditions over a specified time. One metric of application reliability, which stakeholders 108 may desire to improve may be mean time to failure. Mean time to failure may include the average time an application operates before experiencing a failure. A second metric of application reliability, which stakeholders 108 may desire to improve may be error rate. Error rate may include the percentage of requests or transactions that fail (e.g., failed login attempts due to server issues). A third metric of application reliability, which stakeholders 108 may desire to improve may be recovery time. Recovery time may include how quickly the application recovers from failures (e.g., recovery after a server crash). Stakeholders 108 may desire reliable applications to reduce the risk of disruptions, ensure consistent user satisfaction, and lower the operational costs associated with unplanned outages or bugs.

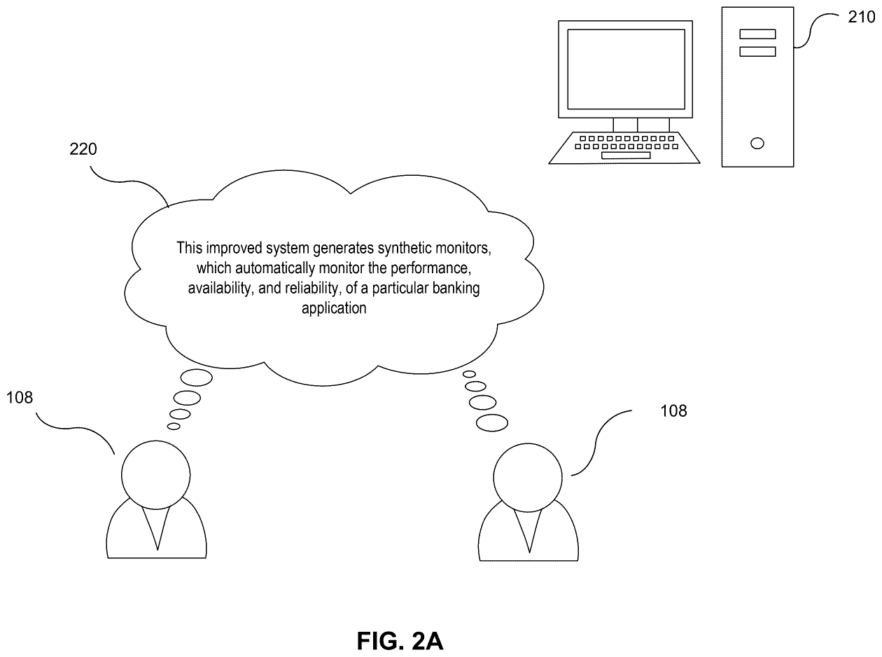

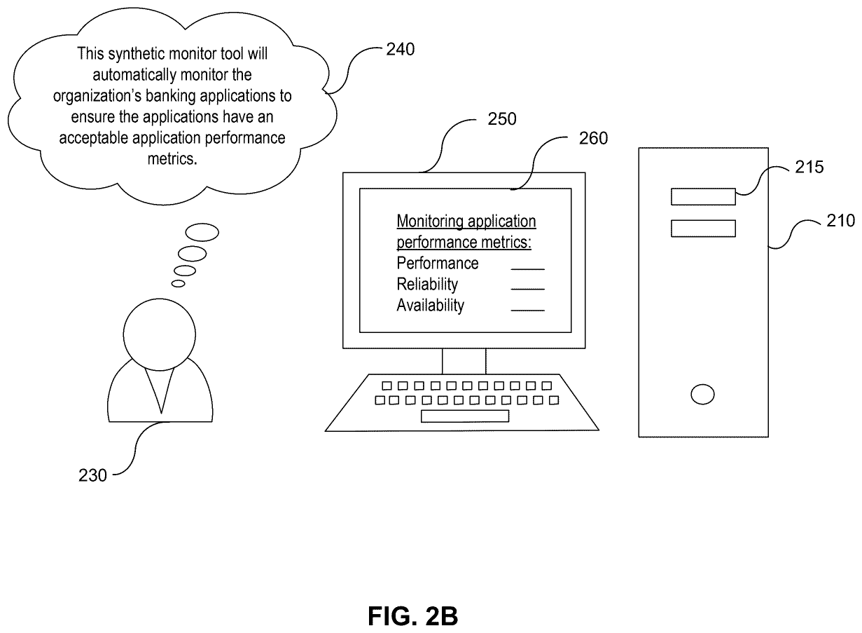

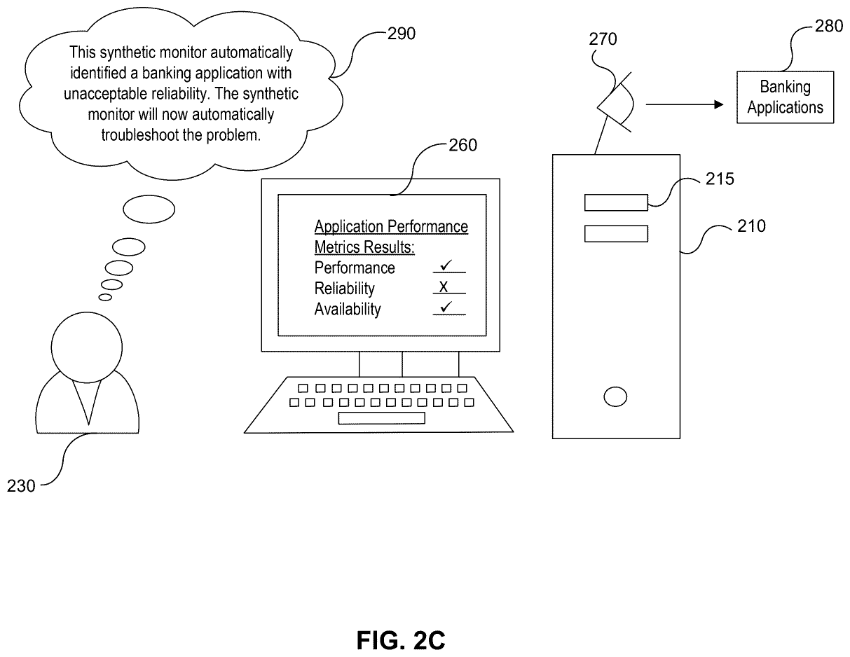

FIG. 2A is a schematic diagram of members of an institution referring to a system directed to improving system responsiveness, consistent with some disclosed embodiments. Stakeholders 108 may agree on an idea 220 to accomplish their desire 109 from FIG. 1; to develop a synthetic monitor management tool that relies on processor 210 configured to generate synthetic monitors, which automatically monitor the performance, availability, and reliability, of a particular banking application. The user of the tool may be one or more members of an organization's IT department or others tasked with maintaining the performance, availability, and reliability of a particular application such as an online banking application.

FIG. 2B is a diagram of a user utilizing a system directed to automatically monitoring application metrics, consistent with some disclosed embodiments. User 230 expresses 240 that a synthetic monitor 250 will automatically monitor the organization's banking applications to ensure the applications have acceptable application performance metrics 260, such as performance, reliability, and availability. In some embodiments, the acceptability of a particular banking application's performance metrics 260 may be based in part on the particular needs of the application. As an example, an application related to a client's ability to contact or chat with customer service or an application related to a client's ability to access and make changes to their online bank accounts may require higher levels of performance, availability, or reliability than other applications. In some embodiments, the synthetic monitor 250 automatically determines the acceptable performance metrics 260 for each particular banking application based on its needs. In other embodiments, the user 230 may review the acceptable performance metrics 260 determined by the synthetic monitor 250. In still other embodiments, the user 230 may determine the acceptable performance metrics for each particular banking application. The performance metrics 260 may be saved on memory 215 and may be used by a synthetic monitor 250, which may be controlled by processor 210. Processor 210 may be local or remote.

FIG. 2C is a diagram of a system directed to improving system responsiveness, consistent with some disclosed embodiments. Synthetic monitor 270, which was created in FIG. 2B, relying on processor 210, which references instructions stored on a memory 215, monitors a particular online banking application 280. While monitoring the particular online banking application 280, the synthetic monitor 270 may determine whether the online banking application 280 is satisfying one or more application performance metrics 260. In the event that the synthetic monitor 270 determines that the online banking application 280 is not satisfying one or more application performance metrics 260, the synthetic monitor 270 may automatically take action to troubleshoot the problem. In the exemplary embodiment depicted in FIG. 2C, the synthetic monitor 270 determines that the online banking application 280 is not satisfying the “reliability” application performance metric 260. In some embodiments, the synthetic monitor 270 may also notify user 230 about the issue upon determining the online banking application 280 is not satisfying one or more application performance metrics 260. Thus, the online banking application 280 that was not meeting acceptable application performance metrics 260 is efficiently and automatically identified and remedied.

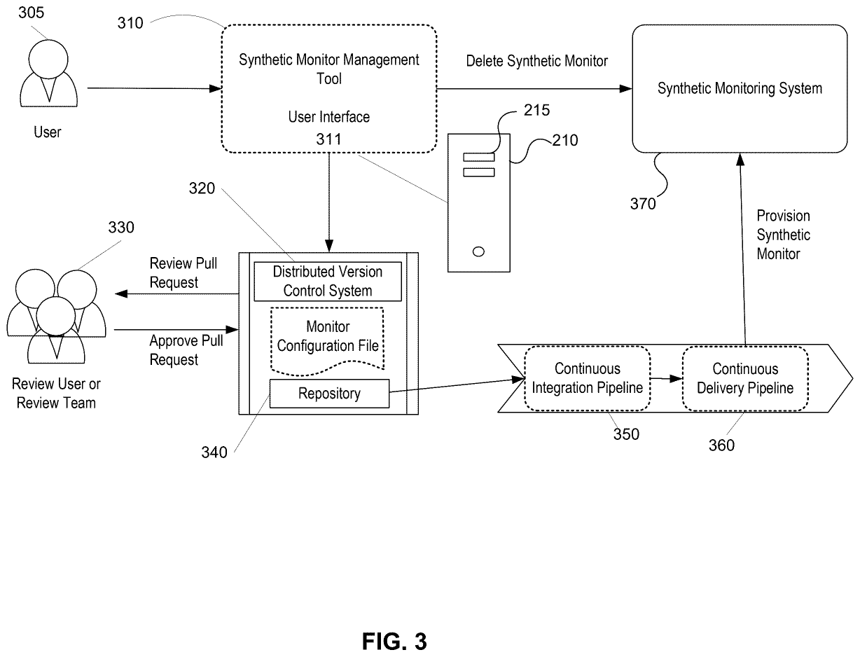

FIG. 3 is a schematic block diagram of a system capable of managing synthetic monitors, consistent with disclosed embodiments.

A synthetic monitor management tool 310 may refer to a tool that user 305 may utilize to submit requests to create and manage synthetic monitors. The tool may automatically create or edit a synthetic monitor based on the user's 305 request. Synthetic monitors may monitor certain application performance metrics, such as performance, availability, and reliability, of a particular application. In some embodiments, the user 305 may submit a request to create and manage synthetic monitors to the synthetic monitor management tool 310 via user interface 311. In other embodiments, synthetic monitor management tool 310 may automatically submit requests based on predefined rules or configurations. The synthetic monitor management tool 310 may have a web-based user interface 311 for a user 305 to submit a request to create, manage, or delete synthetic monitors.

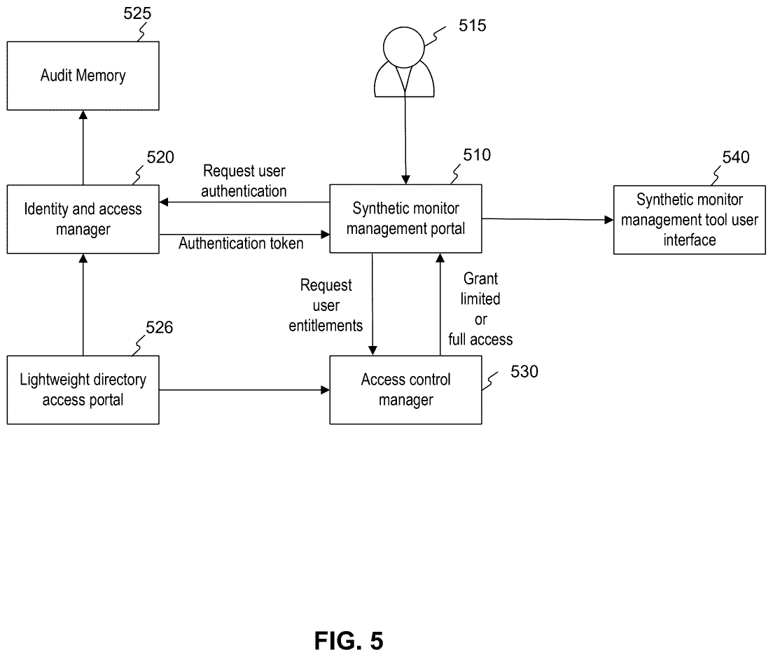

The synthetic monitor management tool 310 may verify the user's identity through an identity and access manager (“IAM”) before granting access to the tool. This step may ensure that authenticated users are interacting with the system, reducing the risk of unauthorized access to synthetic monitoring configurations. The IAM will be further described with respect to FIG. 5.

The synthetic monitor management tool 310 may serve as the primary interface for defining monitoring configurations, such as specifying test scenarios or endpoints to monitor. The synthetic monitor management tool 310 may be controlled by a processor, which references instructions stored on a memory, as described herein.

The synthetic monitor management tool 310 may provide a centralized user interface 311 for user 305 to submit requests to create and manage synthetic monitors. “Managing” a synthetic monitor may encompass creating, updating, editing, or deleting one or more synthetic monitors.

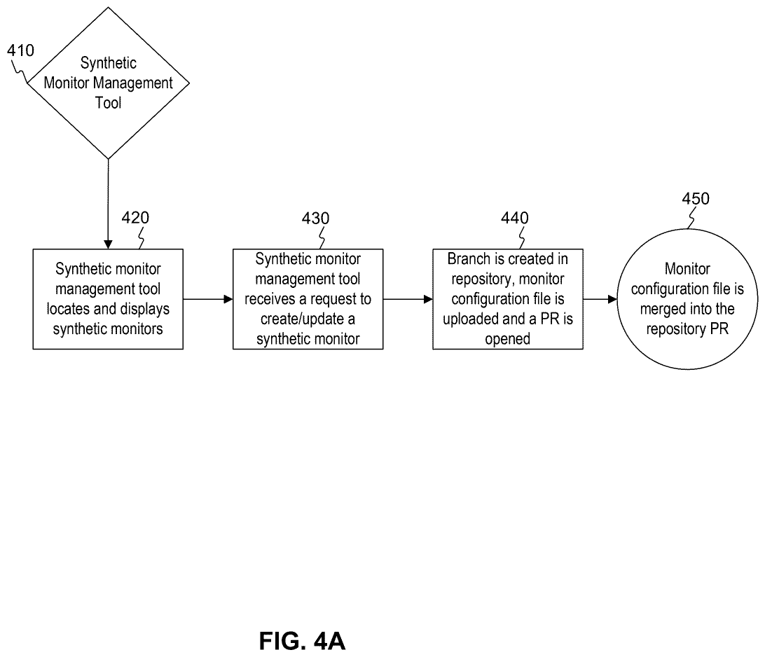

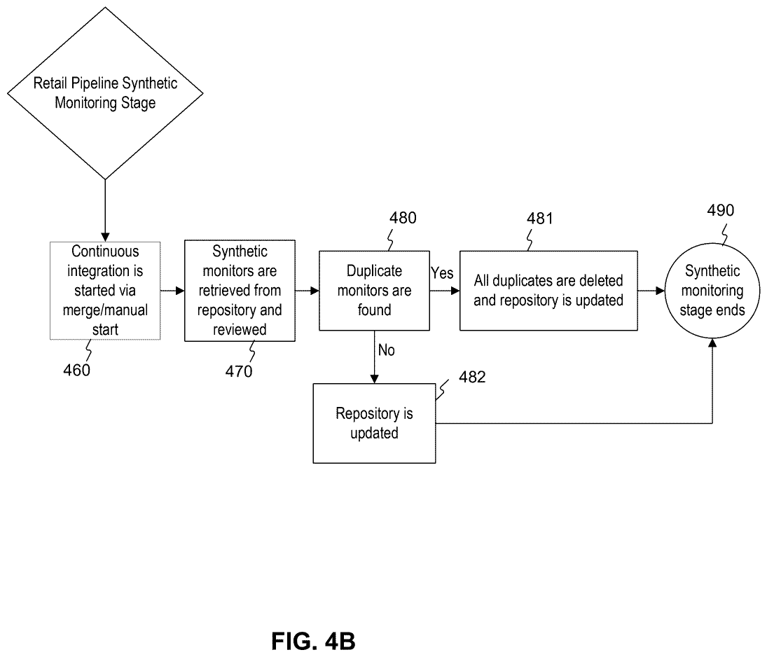

The synthetic monitor management tool 310 may receive the user's request via user interface 311 to generate or update a synthetic monitor configuration file. In response, the synthetic monitor management tool 310 may prepare a new or modified configuration file for inclusion in the version control system. The process for navigating the synthetic monitor management tool 310 is provided in more detail with respect to FIGS. 4A and 4B. For example, if a user 305 desires to update an existing synthetic monitor, the user 305 may first find the existing synthetic monitor in the user interface 311 of the synthetic monitor management tool 310, followed by requesting the synthetic monitor management tool to make the desired changes to the synthetic monitor via a synthetic monitor configuration file, as detailed below. After the user 305 submits the request for the desired change to the chosen synthetic monitor, the user interface 311 of the synthetic monitor management tool 310 may reflect those changes before or after the changes are implemented, following the processes outlined below. If a user 305 submits a request to delete an existing synthetic monitor, the synthetic monitor management tool 310 may automatically find the existing synthetic monitor and then the synthetic monitor management tool 310 may delete the relevant synthetic monitor. This deletion may then be reflected in the user interface 311. In other embodiments, the user 305 may review the synthetic monitor located by the synthetic monitor management tool 310 before the synthetic monitor management tool 310 automatically deletes the synthetic monitor.

A synthetic monitor configuration file may be a structured file (synthetic monitor configuration file) and may include a set of parameters that define the synthetic monitor. The synthetic monitor configuration file may specify the conditions (sometimes called monitoring rules or parameters) for automated monitoring of applications, APIs, or other digital services. A condition or parameter may include a synthetic monitor identifier code, description, a project identifier, an endpoint, a monitoring method, a monitoring schedule, a monitoring frequency, a monitoring interval, a monitoring location, a monitoring timeout, an alert threshold, a notification channel, an escalation policy, or a success criterion.

A synthetic monitor identifier code may be a unique alphanumeric string that may be used to distinguish one synthetic monitor from another within a monitoring system or repository.

A description may be a textual summary that may provide context or purpose for the synthetic monitor, helping stakeholders understand its intended function or scope.

A project identifier may be a label, code, or reference that may associate the synthetic monitor with a specific project, initiative, or organizational unit.

An endpoint may be a network address, URL, or service location that may serve as the target for the synthetic monitor's operations, such as an API, web application, or server.

A monitoring method may refer to the technique or protocol used to simulate user activity or system checks, which may include HTTP requests, browser automation, or scripted interactions.

A monitoring frequency may indicate how often the synthetic monitor may be run, which may vary from every few seconds to once per day depending on operational needs of the organization or of the particular application.

A monitoring interval may specify the time gap between successive executions of the synthetic monitor, which may be configured to balance performance and resource usage.

A monitoring location may refer to the geographic or network origin from which the synthetic monitor may be executed, which may include cloud regions, data centers, or edge nodes.

A monitoring timeout may define the maximum duration the synthetic monitor may wait for a response before considering the attempt unsuccessful or incomplete.

An alert threshold may be a predefined condition or metric value that, when exceeded or unmet, may trigger an alert or notification to a relevant stakeholder, such as user 305.

A notification channel may be any medium through which alerts or updates may be communicated to a stakeholder, such as user 305, such as email, SMS, messaging platforms, or incident dashboards.

An escalation policy may outline the procedures or hierarchy for escalating unresolved issues detected by the synthetic monitor, which may involve notifying higher-level support or management teams.

A condition may refer to a predefined rule or requirement that determines when, how, or under what circumstances a synthetic test should execute or trigger an alert. Conditions may be used to control monitoring behavior dynamically based on external factors. Examples of a condition may include trigger conditions, preconditions, and conditional execution rules. Under trigger conditions, a test may execute when a specific event occurs (e.g., an API endpoint returns an unexpected response). Under preconditions, a test may require certain dependencies to be met before execution (e.g., user authentication must succeed before testing a checkout flow). Under conditional execution rules, a test may execute differently based on input parameters (e.g., different monitoring settings for production vs. staging environments). Conditions may help ensure monitoring tests are context-aware and execute when meaningful, reduce unnecessary synthetic tests that may skew monitoring data, and allow dynamic test behavior based on real-world conditions.

A monitoring schedule may refer to a predefined time-based rule that dictates when and how frequently synthetic monitoring tests run. Scheduling ensures that tests are executed consistently over time to detect performance trends and anomalies. Examples of a schedule may include fixed interval scheduling, time-window-based scheduling, and geolocation-based scheduling. Under fixed interval scheduling, a test may run every 5 minutes, 1 hour, or daily at a specified time. Under time-window-based scheduling, a test may execute during business hours or specific maintenance windows. Under geolocation-based scheduling, a test may execute at different times for different regions (e.g., monitoring a global API from different time zones). A schedule may help ensure monitoring tests align with real-world usage patterns (e.g., peak traffic hours); prevent unnecessary test execution, reducing monitoring costs; and allow targeted monitoring based on business needs (e.g., testing a retail website more frequently during a sale). Additionally, scheduling may allow organizations to test performance before and after software updates, helping confirm that changes do not introduce new problems. When a scheduled time arrives, the synthetic monitor may begin its test by sending simulated requests to the system or application being monitored. It may then measure how quickly and accurately the system responds, and record any issues such as errors or slow performance. The server may support this process by keeping track of the schedule, launching the monitor at the right time, and storing the results for later review. The server may also manage system resources to ensure the monitor runs smoothly without interfering with other tasks, such as by delaying monitoring when the server is busy or is low on memory.

Success criteria may refer to a set of predefined thresholds or conditions that determine whether a synthetic monitoring test passes or fails. Success criteria may help define acceptable performance benchmarks for applications and APIs.

Examples of success criteria may include response time thresholds, HTTP status code, and content validation. Under response time thresholds, the test may pass if the API response time is, for example, less than 500 milliseconds. Under HTTP status code, the test may pass if the HTTP response code is 200 OK, which may refer to the client's request being successful and that the server returned the requested resource. Under content validation the test may pass if a specific keyword or JSON object is present in the response.

By defining specific and clear success criteria, users may be able to obtain meaningful performance data from synthetic monitors, making it easier to detect and troubleshoot issues; and prevent false positives or negatives by setting precise validation rules. Success criteria may make it easier to detect and troubleshoot issues because clear success criteria may allow synthetic monitors to pinpoint where a service fails, enabling faster identification and resolution of problems. Success criteria may help prevent false positives or negatives by ensuring that only genuine service failures—those predefined as success criteria—trigger alerts, reducing noise and avoiding misleading signals that could mask real issues or cause unnecessary escalations.

If the synthetic monitor determines that a certain success criteria is not met, the synthetic monitor may refer to an associated runbook for the next steps. A runbook may be a set of instructions or remediation steps to follow when a specific issue occurs. The set of instructions in the runbook may be predefined by a user. For example, a runbook may have predetermined instructions to restart the database if database connectivity error code 1234 occurs. Thus, upon receiving error code 1234, the synthetic monitor will refer to its associated runbook and execute the steps required to restart the database.

The synthetic monitor management tool 310 may create a pull request in a distributed version control system 320 with the new or modified configuration file.

The distributed version control system 320 may be a system that manages repositories and enables version control operations, along with ensuring that every change to a configuration file is versioned with a version identifier, traceable, and reversible. The distributed version control system 320 may allow multiple users 305 to work on a project simultaneously by keeping track of certain or all changes across multiple copies of the repository. The distributed version control system 320 may act as a central repository via a memory for tracking certain or all synthetic monitor configuration versions, providing a history of changes and the capability to revert or “rollback” to a prior version. The distributed version control system 320 may be decentralized, meaning that every user has a full copy of the repository, including its entire version history. The distributed version control system 320 may allow branching and merging, meaning that it supports parallel development by allowing users to work on separate branches before merging changes. Branching may be the process of creating an independent copy of the main project (repository) to work on changes without affecting the original version. A branch allows users to develop new features, fix bugs, or experiment without impacting the main codebase. Merging may be the process of integrating changes from one branch into another. Once a feature or bug fix is completed and tested, it is merged back into the main branch or another relevant branch.

The pull request may be a formal request to merge the new or updated configuration into the repository, ensuring versioning and collaboration. Pull requests may be created and managed in the distributed version control system 320, ensuring collaboration and review of any changes to synthetic monitors. Instead of making changes directly to the main repository, contributors may first make edits in a separate branch and submit a pull request to propose incorporating those edits into the main branch. By making pull requests within a distributed version control system, the pull requests may be tracked, recorded, and associated with a unique commit history, which may ensure that any synthetic monitor configuration change is versioned, meaning previous states of the configuration remain accessible, making it possible to rollback if needed. The ability to rollback may be helpful for troubleshooting issues, as teams can revert to a previous version if a newly introduced change causes problems.

This integration between the synthetic monitor management tool 310 and the distributed version control system 320 may enable version control for certain or all synthetic monitor configurations. Version control may provide benefits including traceability, auditability, and collaboration, which may be absent in traditional synthetic monitoring setups.

Traceability may refer to the ability to track and document every change made to synthetic monitor configurations, including who made the change, when it was made, and what was changed. By storing configurations in a distributed version control system 320, every change to a configuration may be automatically logged, associated with a unique commit identifier, timestamp, and author. A commit identifier may be a unique identifier assigned to each commit (change(s) to a repository) in the distributed version control system 320. Alternatively, making configurations directly in the monitoring system's interface may not be conducive to retaining a detailed change log or historical record. Without a clear mechanism to track modifications, it may become difficult to identify the root cause of errors or inconsistencies if an issue arises.

Auditability may ensure that there is a verifiable, comprehensive record of certain or all actions related to synthetic monitor configurations. This may include the ability to review changes and validate compliance with organizational policies or external regulations. The distributed version control system 320 may maintain a permanent history of every change to configuration files, along with metadata (e.g., commit messages, timestamps, user identities). Without proper auditability, changes made through the synthetic monitoring system's interface may be applied immediately and without creating a detailed record. A lack of a durable audit trail may make it difficult to review past actions or validate adherence to organizational policies or external regulations.

Additionally, corporations may have metrics related to service health and availability that can be corroborated by way of audit files. The audit trail shows proof that users have executed the tests and that users are finding issues in production before the issues are encountered by customers.

Collaboration may refer to the ability for multiple team members to work together efficiently on managing and improving synthetic monitors, with mechanisms for reviewing, commenting on, and approving changes. The use of pull requests in the version control repository may foster collaboration by allowing team members to propose, review, and discuss changes before they are merged. For example, a developer might suggest changing the frequency of a monitor from 10 minutes to 5 minutes in a pull request. A senior team member may review the proposed change, leave comments (e.g., “Is this frequency necessary? Will it increase costs?”), and request modifications if needed. Once certain or all stakeholders agree, the change is approved and merged into the repository by merging the synthetic monitor configuration file into a predefined folder structure within the repository. Systems without version control may limit collaboration, which may lead to errors, inconsistencies, and missed opportunities for improvement because changes are not subject to peer review, scrutiny, or discussion.

The distributed version control system 320 may then send the pull request to a review user or review team 330 (e.g., a developer or admin), who may inspect, discuss, and approve the pull request. The distributed version control system 320 may then receive approval from the review user or review team 330 before merging the monitor configuration file into the repository 340, creating an updated repository 340. This step adds a layer of review to ensure the accuracy and appropriateness of monitoring changes. The review user or review team 330 may use certain criteria to decide whether to approve the pull request in the distributed version control system 320, such as the pull request's impact on other configurations, whether the pull request properly accomplishes the desired outcome, and whether the pull request would introduce security vulnerabilities or expose sensitive information.

The formal review mechanism for each pull request may also improve auditability by ensuring that certain or all changes are approved and validated before being applied to the monitoring system. This formal review mechanism may be especially valuable for organizations with strict compliance requirements for internal quality controls, for example banking organizations.

The distributed version control system 320 may provide for version control for certain or all monitor configuration files being stored or saved in one place, e.g., the repository 340, which may contain pre-specified folders for certain or all monitor configuration files. Pull requests may be created and managed in the distributed version control system 320, ensuring collaboration and review of any changes to synthetic monitors.

The distributed version control system 320 may integrate with a continuous integration pipeline 350 to automatically test configuration files in a development environment before merging. For synthetic monitoring, such tests may include syntax validation to ensure the configuration file is properly formatted, and simulation tests to verify that the monitor will function as expected according to the synthetic monitor configuration file's conditions or parameters. If the configuration files fail testing, the pull request may be flagged for corrections before it can be merged, which may reduce or prevent faulty configurations from being deployed.

The continuous integration pipeline 350 may be triggered automatically by changes in the repository. The continuous integration pipeline 350 may read the monitor configuration files from the updated repository, and validate the settings to help ensure the synthetic monitors will function with the new monitor configuration files in the updated repository 340.

After reading and validating the monitor configuration files, the continuous integration pipeline 350 may send the updated repository 340 to a continuous delivery pipeline 360 to provision the monitor configuration files into the synthetic monitoring system 370. The continuous integration pipeline 350 and the continuous delivery pipeline 360 may work together to automate the validation, testing, and deployment of changes, for example, to a synthetic monitoring system. One goal of a continuous integration pipeline 350 may be to ensure that modifications-whether related to software, infrastructure, or configurations-are consistently and efficiently applied across environments. By integrating automated checks and version control, the CI/CD pipelines ensure that every change is tested and verified before being deployed, reducing the risk of environment-specific errors. These pipelines enforce uniform deployment procedures, which may eliminate inconsistencies and guarantee that updates behave identically across development, staging, and production environments. This consistency not only improves reliability but also accelerates delivery cycles by streamlining the rollout of validated changes.

A continuous integration pipeline 350 may begin when a change is committed to the version-controlled repository 340. This change may involve updates to source code, infrastructure configurations, or synthetic monitoring parameters. An automated trigger may initiate the continuous integration pipeline 350, ensuring that every modification follows a structured process.

The continuous integration pipeline 350 may next verify whether the change meets predefined requirements. In other words, the continuous integration pipeline 350 may be responsible for testing and building the monitor configuration files into the final image. Validation may include syntax checks, static analysis, and policy enforcement. Syntax checks may ensure the monitor configuration files are formatted correctly. Static analysis may detect potential issues in the update. If issues are detected, the continuous integration pipeline 350 may flag the error to the user 305 through the synthetic monitor management tool 310 user interface 311 or via a direct communication to the user 305, for example via email. Policy enforcement may confirm compliance with security or operational guidelines. If validation and testing steps are not successful, the continuous integration pipeline may alert or notify the user or relevant teams about potential failures or degraded performance. In some embodiments, the continuous integration pipeline may respond by providing potential resolution solutions to the potential failures or the degraded performance. In some embodiments, the continuous integration pipeline may provide updates based on the response to the potential failures or degraded performance. In some embodiments, the continuous integration pipeline may provide an escalation path based on a level of the potential failure or a threshold being met with respect to the potential failure or the performance degradation. If validation and testing steps are successful, the continuous integration pipeline 350 may proceed with sending the update to the continuous delivery pipeline 360.

Then, the continuous delivery pipeline 360 may conduct testing to assess the impact of the change. Possible tests may include unit testing, integration testing, performance testing, and synthetic monitoring validation. Unit testing may ensure that individual components function correctly. Integration testing may verify that the updated component interacts properly with other systems. Performance testing may measure response times or system efficiency under the new configuration. Synthetic monitoring validation may confirm that conditions or monitoring rules are correctly structured and applied.

In certain embodiments, the continuous delivery pipeline 360 may test the monitor configuration files across a sequence of computing environments. These environments may include one or more non-production environments, such as development, testing, or staging environments, and at least one production environment.

A non-production environment may refer to a computing environment that is isolated from end-user access and may be used for internal development, integration, or validation activities. These environments may simulate aspects of the production environment rather than being intended to serve live user traffic. In contrast, a production (or operating) environment may refer to the computing environment in which the application or service is made available to end users and is expected to operate with high reliability and performance.

In some implementations, when a synthetic monitor is created or modified, it is initially deployed to a non-production environment. The continuous delivery pipeline 360 may be configured to evaluate the operational status of the synthetic monitor within that environment. For example, the continuous delivery pipeline 360 may determine whether the monitor executes successfully, returns expected results, or satisfies one or more predefined performance thresholds. Such a non-production environment testing may be instead of or in addition to the review user or review team 330 process.

If the monitor fails to meet the applicable criteria in the non-production environment, the continuous delivery pipeline 360 may be configured to prevent or delay the promotion of the associated monitor configuration files to the production environment. This enforcement mechanism may serve as an automated validation step, ensuring that only monitor configuration files that demonstrate acceptable behavior in a controlled setting are eligible for deployment to environments with broader impact.

Such a mechanism may reduce the likelihood of introducing misconfigured or non-functional monitors into the production environment, thereby enhancing system reliability, potentially without requiring manual review or centralized governance.

Then, the continuous deployment pipeline 360 may deploy the update to the synthetic monitoring system 370. Deployment by the continuous delivery pipeline 360 may occur in a staging environment or production environment. A staging environment may be a controlled area where updates can be reviewed before going live. A production environment may be the live system where changes take effect. In some embodiments, the continuous delivery pipeline 360 may include a manual approval step before deployment, while in other embodiments, continuous delivery pipeline 360 deployment may rely entirely on automation. The continuous delivery pipeline 360 may continue to track the synthetic monitoring system's 370 performance to detect issues, and if a problem arises, the continuous delivery pipeline may allow for automatic rollback—restoring a previous version of the synthetic monitoring system or alerts and notifications—informing relevant teams about potential failures or degraded performance.

Using the continuous integration pipeline 350 and/or the continuous delivery pipeline 360 may help ensure consistent, repeatable, and error-free deployments of synthetic monitors, which may reduce or minimize manual intervention. A continuous delivery pipeline 360 may enable frequent, incremental updates rather than large, infrequent changes. This interaction between the continuous delivery pipeline 360 and the synthetic monitoring system 370 may be via an application programming interface (API).

By automatically executing the synthetic monitor management request from user input at the user interface 311 level, through distributed version control 320, review team 330 approval, repository 340 storage, CI pipeline 350 testing, CD pipeline 360 provisioning, the synthetic monitor management tool 310 may reduce or eliminate the need for direct configuration in the synthetic monitoring system because configuration updates may occur automatically.

If the user 305 chooses to delete a synthetic monitor, the synthetic monitor management tool 310 may send a delete request directly to the synthetic monitoring system 370, thus removing the chosen synthetic monitor from the system. This provides a direct pathway for deprovisioning monitors without requiring changes in the configuration repository or extensive approval processes.

FIG. 4A is a flow diagram of a method of integrating new or updated synthetic monitors into the repository using a synthetic monitoring tool, consistent with disclosed embodiments.

A user (e.g., a developer or admin) may desire to create or manage a synthetic monitor. In step 410, the synthetic monitor management tool may authenticate a user's access request. The process of the synthetic monitor management tool authenticating a user's access request is further described with respect to FIG. 5.

In step 420, the synthetic monitor management tool may locate and display the existing synthetic monitor and its associated configuration files that the user desires to manage or delete based on at least one parameter. Alternatively, the synthetic monitor management tool may locate and display several existing synthetic monitors and their associated configuration files that the user may desire to view based on at least one parameter. Locating one or more existing synthetic monitor may include querying a repository to identify one or more synthetic monitors based on the at least one parameter. A repository may be a version-controlled storage location, where monitor configuration files, scripts, or monitoring definitions are managed. A parameter may include a synthetic monitor identifier code, description, a project identifier, an endpoint, a monitoring method, a monitoring schedule, a monitoring frequency, a monitoring interval, a monitoring location, a monitoring timeout, an alert threshold, a notification channel, an escalation policy, or a success criterion.

In step 430, the synthetic monitor management tool may receive a request from a user device to create a new, or update an existing, synthetic monitor configuration file via the synthetic monitoring management tool user interface.

In step 440, the synthetic monitor management tool may create a branch in the repository and upload the new or updated monitor configuration file into the branch. The synthetic monitor management tool may then monitor the branch to ensure the new or updated monitor configuration file is performing correctly. The synthetic monitor management tool may then create a pull request to merge the new or updated monitor configuration file into the repository. The pull request may require approval by a review user or review team (e.g., a developer or admin), who may inspect, discuss, and approve the pull request. The review user approval process is explained in the detailed description of FIG. 3.

In step 450, the user or the synthetic monitor management tool may merge the pull request into the repository, thereby updating the repository with the new or updated monitor configuration file.

FIG. 4B is a flow diagram of a method of deploying new or updated synthetic monitors using a synthetic monitoring tool, consistent with disclosed embodiments.

In step 460, a continuous integration pipeline may automate the process of merging the monitor configuration file changes from multiple developers into a shared repository. This ensures that the monitor configuration file updates are regularly built and tested, helping catch errors early in the development cycle. In step 460, the continuous integration pipeline may also validate a modification to the synthetic monitor configuration file; a process which is described in FIG. 3.

In step 470, the continuous integration pipeline may review certain or all current monitor configuration files in the repository.

In step 480, the continuous integration pipeline may determine whether any duplicate monitor configuration files are in the repository.

In step 481, if the continuous integration pipeline determines that one or more duplicate monitor configuration files are in the repository, the continuous integration pipeline may delete such duplicates and then update the repository with the new or updated monitor configuration file or the continuous integration pipeline may alert the user upon determining that one or more duplicate monitor configuration files are in the repository. The continuous integration pipeline may determine that one or more duplicate monitor configuration files are in the repository if the instructions or conditions for two or more monitor configuration files in the repository are identical. Duplicate monitor configuration files may refer to monitor configuration files that have at least one parameter that is the same between the two monitor configuration files.

In step 482, if the continuous integration pipeline determines that no duplicate monitor configuration files are in the repository, a continuous delivery pipeline proceeds to update the repository with the new or updated monitor configuration file.

At step 490, the synthetic monitoring stage may end. Alternatively, at step 490 the continuous delivery pipeline may continue to track the new or updated synthetic monitor to detect issues. If the continuous delivery pipeline detects issues, the continuous delivery pipeline may perform an automatic rollback, where a previous version of the monitor configuration file is located from the distributed version control system and restored. Or if the continuous delivery pipeline detects issues, the continuous delivery pipeline may alert or notify the user or relevant teams about potential failures or degraded performance.

FIG. 5 is a schematic block diagram of a system capable of validating a user of a synthetic monitor management tool, consistent with disclosed embodiments.

A synthetic monitor management portal 510 may enable a user 515 to create, manage, or delete synthetic monitors. The user 515 of the synthetic monitor management portal 510 may be one or more members of an organization's IT department or others tasked with maintaining the performance, availability, and reliability of a particular application such as an online banking application. In some embodiments, when a user 515 attempts to submit a request to create, manage, or delete a synthetic monitor, the user 515 must first be authenticated and their entitlements must be verified.

The synthetic monitor management portal 510, via a processor, may send a request to authenticate the user's identity to an identity and access manager (IAM) 520 before granting access to the synthetic monitor management tool's user interface 540. This step of authenticating the user's identity may ensure that authenticated users can interact with the synthetic monitor management tool, reducing the risk of unauthorized access to synthetic monitoring configurations.

The IAM 520 may be a framework of policies, technologies, and processes used to manage user identities, authentication, and access privileges within an organization. The IAM 520 may provide user authentication by verifying the identity of users through methods such as passwords, multi-factor authentication, and single sign-on. The IAM 520 may further provide authorization management by granting or restricting access based on roles, policies, and access control rules. The IAM 520 may further provide identity federation by allowing users to access multiple applications through a centralized identity provider. The IAM 520 may further provide audit and compliance tracking by logging user actions in audit memory 525 for security audits and compliance enforcement.

When the user 515 attempts to log into the synthetic monitor management portal 510 via a user interface, the synthetic monitor management portal 510 may send an authentication request to the IAM 520. The IAM 520 may support various authentication mechanisms, including username and password verification, multi-factor authentication, single sign-on (SSO), certificate-based authentication, biometric authentication, or token-based authentication.

A username and password verification method of authentication may mean that the user 515 provides a unique identifier (e.g., a username) and a secret key (e.g., a password) to access a system. The IAM 520 may compare the entered credentials against stored records to determine if access should be granted. The security of the username and password verification method of authentication may be improved by organizations by implementing additional measures such as password hashing, complexity requirements, and account lockout policies. If using username and password verification, the user may provide credentials, which the IAM system may validate against a secure database, such as a Lightweight Directory Access Protocol (LDAP) 526.

The LDAP 526 may serve as a centralized database that stores user account information, access control lists, and organizational hierarchies. User account information may include usernames, email addresses, and group affiliations. Access control lists may define which resources or applications a user may access. Organizational hierarchies may structure users into groups and roles based on departments or job functions.

A multi-factor authentication (MFA) method of authentication may mean that the user 515 must verify their identity using more than one form of authentication from different categories, such as something they know (password), something they have (a mobile device or token), or something they are (biometrics). This approach may increase security by requiring an additional step beyond a password, making unauthorized access more difficult even if credentials are stolen. Common MFA implementations may include one-time passcodes sent via short messaging service (SMS) or email, authenticator apps, or biometric verification. For organizations that use SSO, the IAM 520 may redirect the user 515 to the SSO service, where they may authenticate once and gain access to multiple applications, including the synthetic monitor management portal 510.

Whether or not the user successfully authenticates, the IAM 520 may store the user's attempt to verify the user device in audit memory. Upon receiving the user request, a processor may assign a commit identifier, timestamp, and author to the request. In such embodiments where the IAM 520 may store the user's attempt to verify the user device in memory, the request's commit identifier, timestamp, and author may also be saved in the audit memory 525.

If the user successfully authenticates, the IAM 520 may generate a session token or authentication token. This token may be a JSON Web Token (JWT) or another secure identifier that proves the user's identity. The token may be sent back to the synthetic monitor management tool, allowing the user to proceed to the next step.

The SSO method of authentication may mean that users authenticate once to gain access to multiple systems without needing to log in separately to each one. This approach may rely on an identity provider to issue a session token that grants access to connected applications, reducing the need for users to remember multiple passwords. SSO may improve convenience and reduce password fatigue, while also enhancing security by centralizing authentication controls.

A certificate-based authentication method may mean that users authenticate using a digital authentication certificate issued by a trusted certificate authority rather than entering a password. The system may verify the certificate's authenticity to determine whether access should be granted, making the system resistant to phishing and password-related attacks. This approach may be used in enterprise environments for securing network access, as well as in TLS/SSL encryption for websites. Certificate-based authentication may require careful management of certificate issuance, renewal, and revocation.

A biometric authentication method may mean that users verify their identity using a biometric identifier, or unique biological characteristics such as fingerprints, facial recognition, iris scanning, or voice recognition. This method may enhance security by leveraging physical traits that are difficult to replicate, reducing reliance on passwords. Biometric authentication may be commonly used in mobile devices, secure access systems, and identity verification solutions.

A token-based authentication method may mean that users receive a secure authentication token after a successful login, which is then used to access protected resources without needing to re-enter credentials. This approach may be used in web applications and APIs, where JSON Web Tokens (JWTs) or OAuth access tokens provide session authentication. Because tokens may be time-limited and stateless, they may reduce the risk associated with storing session data on servers. To increase security for token-based authentication methods, organizations may implement measures such as token expiration policies, encryption, and refreshing tokens that may be important for maintaining security.

If authentication fails due to incorrect credentials, expired access, or failed multi-factor verification, the user 515 may be denied access, and the process may stop at this stage. The user authentication steps may provide an audit trail of user actions, which may improve security and compliance.

After successfully authenticating the user, the synthetic monitor management portal may determine what actions the user is authorized to perform. This process, known as entitlement verification, may ensure that the user 515 can access features and modify synthetic monitors according to their role and permissions.

To retrieve the user's entitlements, the synthetic monitor management portal may send a request to access control manager 530. The LDAP 526 may manage user roles, group memberships, and privilege levels, allowing the access control manager 530 to determine whether the user 515 has the necessary permissions to create, update, or delete synthetic monitors.

Several checks may be performed in this step. The access control manager 530 may first verify whether the user belongs to predefined roles, such as administrator, developer, or read-only user, through role-based access control. If the organization uses group-based permissions, the access control manager 530 may check which groups the user is assigned to, such as the monitoring team, site reliability engineers, security team, or quality control and auditing. Additionally, the access control manager 530 may determine whether the user 515 has permissions for specific actions, such as creating new synthetic monitors, updating existing configurations, deleting monitors, activating or deactivating monitors, or viewing monitoring logs.

The access control manager 530 may then send the user entitlements to the synthetic monitor management portal 510, which may apply access restrictions based on the user's 515 permissions. If the user 515 has full privileges, the user 515 may proceed to create and manage synthetic monitors using the synthetic monitor management tool's user interface 540. If they have read-only access, the user 515 may view monitor configurations using the synthetic monitor management tool's user interface 540, but may not make changes. If the user 515 does not have sufficient entitlements, the system may prevent them from accessing the synthetic monitor management tool's user interface 540 and from performing restricted actions and/or may notify the user that the user's entitlements are insufficient by, for example, displaying an error message.

By enforcing authentication and entitlement checks, the workflow may ensure that authorized personnel modify synthetic monitoring configurations, reducing the risk of misconfigurations or unauthorized changes. This structured approach may enhance security, compliance, and operational control in managing synthetic monitors.

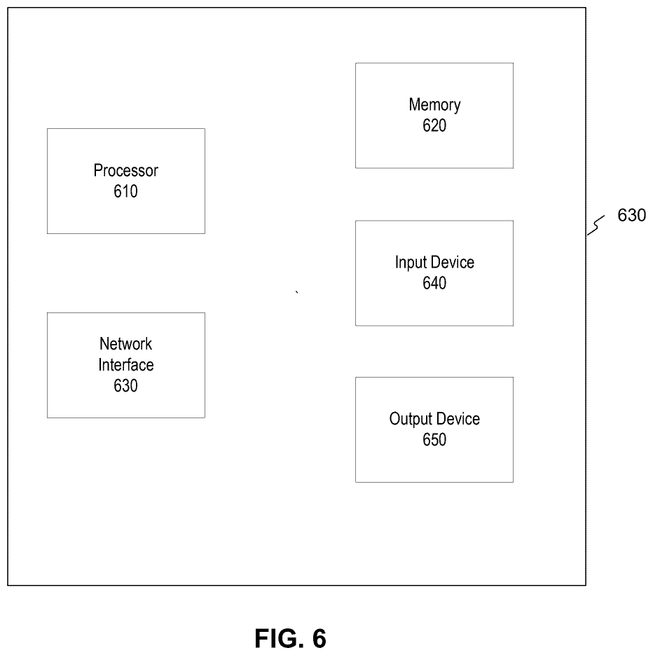

FIG. 6 depicts an example of computing device 600, in accordance with disclosed embodiments. Various operations as described herein may be performed using computing device 600. Computing device 600 may include processor 610 and memory 620 storing instructions that, when executed by the at least one processor, may cause the at least one processor to perform one or more operations as described herein.

Memory 620 may include a non-transitory computer-readable medium that may store instructions and data structures. These instructions may include logic for receiving user requests, generating synthetic monitor configuration files, validating those files, and deploying them to a synthetic monitoring system.

Memory 620 may include sub-groups of memory for specific purposes. For example, memory 620 may include audit memory, which may be a portion of memory 620 that is used for storing certain information that is useful to create an audit trail. The memory 620 may also store authentication credentials, audit logs, and configuration history, enabling traceability and compliance. Memory 620 may include, for example, volatile memory, non-volatile memory, flash drives, caches, registers, hard drives, disks, an optical data storage medium, a physical medium with patterns, random access memory (RAM), read-only memory (ROM), programmable read-only memory (PROM), erasable programmable read-only memory (EPROM), compact disc read-only memory (CD-ROM), digital versatile discs (DVDs), non-volatile random-access memory (NVRAM), or networked versions thereof.

Processor 610 may include, for example, central processing units (CPUs), graphics processing units (GPUs), digital signal processors (DSPs), field programmable gate arrays (FPGAs), integrated circuits, microcontrollers, microchips, microprocessors, or other units suitable for executing instructions or performing logic operations. Processor 610 may include a single-core or multiple-core processor (e.g., dual-core, quad-core, or with any desired number of cores). Processor 610 may provide the ability to execute, run, control, manage, or store multiple processes, applications, or programs. Processor 610 may be configured to execute the instructions stored in memory 620. Upon receiving a request from a user device-such as a request to create, update, or delete a synthetic monitor-the processor 610 may parse the request, authenticate the user, and generate a corresponding configuration file. The processor may also initiate communication with a distributed version control system to create a pull request, trigger validation via a continuous integration pipeline, and deploy validated configurations via a continuous delivery pipeline.

Computing device 600 may further include at least one network interface 630 (e.g., a network card, a modem, and/or any other device that may be configured to provide data communication via a network).

The network interface 630 may enable the computing device 600 to communicate with systems, which may be housed internally or externally, including user devices, identity and access managers, distributed version control systems, CI/CD pipelines, and synthetic monitoring platforms. The network interface may support secure protocols such as HTTPS, TLS, or VPN tunnels to ensure encrypted and authenticated data exchange. For example, when a user submits a request through a web-based interface, the network interface may transmit the request to the processor for handling, and subsequently send validated configuration files to the synthetic monitoring system via an API.

Computing device 600 may further include one or more input devices 640 (e.g., a keyboard, a mouse, a touch screen, a joystick, a touch pad, one or more buttons, a microphone, a sensor, and/or any other device configured to detect and/or receive input). Through the input device 640, users may specify parameters for synthetic monitors, such as endpoints, schedules, success criteria, and alert thresholds. These inputs may be captured by the system's user interface and transmitted to the processor for processing and execution. In some embodiments, a front end interface may be configured to include the interactive graphical user interface such that the front-end interface is configured to exchange digital information containing a status of synthetic monitors with the user via the interactive graphical user interface. In a containerized environment, containers often need to communicate with each other or with external systems. In this context, ports may refer to communication endpoints that allow containers to exchange digital information. Each container may be configured to expose one or more ports to facilitate communication with other containers, services, or external clients. By exposing ports, containers may listen for incoming network requests and send out responses or requests.

Computing device 600 may further include one or more output devices 650 (e.g., a display (e.g., a light-emitting diode (LED) display, a liquid-crystal display (LCD), an organic light-emitting diode (OLED) display, or a dot-matrix display), a screen, a touch screen, a headphone, a speaker, a light indicator, a light source, a device configured to provide tactile cues, a vibrator, and/or any other device configured to provide output). For example, the output device 650 may display the status of synthetic monitors, validation results, audit logs, or error messages. In some embodiments, the output device 650 may also provide visual feedback during authentication, such as indicating whether login credentials were accepted or rejected.

Together, these hardware components may enable a robust and responsive system architecture. The processor 610 and memory 620 may form the computational core, executing logic and maintaining state. The network interface 630 may ensure connectivity and integration with external services. The input device 640 and output device 650 may facilitate user interaction, allowing users to initiate monitoring operations and receive feedback. This integrated hardware configuration may support the management of synthetic monitors as described in the specification.

Although the disclosure has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

1. A system for managing a synthetic monitor comprising:
a memory storing instructions; and
a processor configured to execute instructions to perform operations including:
receive a request from a user device to manage a synthetic monitor;
generate a synthetic monitor configuration file based on the request;
generate a pull request in a distributed version control system for the synthetic monitor configuration file, wherein the distributed version control system is configured to:
update a repository within the distributed version control system by merging the synthetic monitor configuration file into the repository to form an updated repository;
grant access of the updated repository to a continuous integration pipeline configured to:
detect the update of the repository;
verify that the synthetic monitor configuration file meets a set of predefined requirements, wherein the set of predefined requirements is selected from the group consisting of a syntax check, a static analysis, a compliance confirmation, a unit test, an integration test, and a performance test; and
convert the synthetic monitor configuration file to a validated synthetic monitor configuration file; and
grant access of the validated synthetic monitor configuration file to a continuous delivery pipeline, the continuous delivery pipeline configured to:
deploy the validated synthetic monitor configuration file to a synthetic monitor management tool; and
execute the validated synthetic monitor configuration file on the synthetic monitor management tool.

2. The system of claim 1, wherein the request includes a commit identifier, timestamp, and author and wherein the distributed version control system is further configured to save the commit identifier, timestamp, and author for the request in the memory.

3. The system of claim 1, wherein the distributed version control system is further configured to test the synthetic monitor configuration file by conducting one of syntax validation or simulation testing.

4. The system of claim 1, wherein the continuous integration pipeline is further configured to test the synthetic monitor configuration file by conducting one of syntax validation or simulation testing.

5. The system of claim 1, wherein the continuous delivery pipeline is further configured to deploy the validated synthetic monitor configuration file to the synthetic monitor in a staging environment.

6. The system of claim 5, wherein the continuous delivery pipeline is further configured to determine whether the synthetic monitor configuration file satisfies predefined performance thresholds in the staging environment before deployment to a production environment.

7. The system of claim 1, wherein the continuous delivery pipeline is further configured to deploy the validated synthetic monitor configuration file to the synthetic monitor in a production environment.

8. The system of claim 1, wherein before the continuous delivery pipeline deploys the validated synthetic monitor configuration file to the synthetic monitor, the continuous delivery pipeline is further configured to obtain approval from a second user device.

9. The system of claim 1, wherein after the processor executes the validated synthetic monitor configuration file to the synthetic monitor, the continuous delivery pipeline is further configured to continue to monitor the synthetic monitor for one or more performance issues.

10. The system of claim 9, wherein if the continuous delivery pipeline detects one or more performance issues, the continuous delivery pipeline is further configured to either:
revert the validated synthetic monitor configuration file to the synthetic monitor configuration file by retrieving a previous version of the synthetic monitor configuration file from the distributed version control system; or
notify at least one of the user device and a second user device about the one or more performance issues.

11. The system of claim 1, wherein the continuous delivery pipeline is further configured to:
deploy the validated synthetic monitor configuration file to the synthetic monitor via an application programming interface.

12. The system of claim 1, wherein the request from a user device to manage a synthetic monitor comprises specifying at least one parameter to manage for an existing synthetic monitor, wherein the parameter is at least one of a description, a project identifier, an endpoint, a monitoring method, a monitoring schedule, a monitoring frequency, a monitoring interval, a monitoring location, a monitoring timeout, an alert threshold, a notification channel, an escalation policy, or a success criterion.

13. The system of claim 1, wherein the distributed version control system is further configured to:
assign a version identifier to the synthetic monitor configuration file; and
save the version identifier to the memory.

14. The system of claim 1, wherein the distributed version control system is further configured to request an approval from a second user device for the pull request before updating the repository.

15. The system of claim 1, wherein the synthetic monitor configuration file comprises a condition selected from the group consisting of a trigger condition, a precondition, and a conditional execution rule.

16. The system of claim 1, wherein the synthetic monitor configuration file comprises a schedule selected from the group consisting of a fixed interval scheduling, a time-window-based scheduling, and a geolocation-based scheduling.

17. The system of claim 1, wherein the synthetic monitor configuration file comprises a success criterion selected from the group consisting of a response time threshold, an HTTP status code, and content validation.

18. The system of claim 17, wherein the synthetic monitor configuration file includes a runbook, and the synthetic monitor management tool is further configured to execute predefined remediation steps from the runbook when the success criterion is not met.

19. The system of claim 1, wherein the distributed version control system is further configured to maintain an audit trail comprising commit messages, timestamps, and user identities for each synthetic monitor configuration file.

20. The system of claim 1, wherein if the continuous integration pipeline fails to verify that the synthetic monitor configuration file meets a set of predefined requirements, the continuous integration pipeline is further configured to notify the user device of validation failures via the synthetic monitor management tool or direct communication.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)
